(19) United States
(12) Patent Application Publication
(10) Pub. No.: US 2008/0081201 A1
(43) Pub. Date: Apr. 3, 2008

(54) Resin product having luster metallic coating film with discontinuous structure

(75) Inventors: Mamoru Kato, Aichi-ken (JP); Takayasu Ido, Aichi-ken (JP); Hiroshi Watarai, Aichi-ken (JP); Kiyotaka Ito, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 11/889,076

(22) Filed: Aug. 9, 2007

(30) Foreign Application Priority Data
Sep. 28, 2006 (JP) JP2006-264910

(51) Int. Cl. B32B 9/00

(52) U.S. Cl. 428/469; 428/457

(57) ABSTRACT

The present invention provides a resin product which includes a resin base material, a luster metallic coating film provided on the resin base material. The metallic coating film is made of indium, and has a discontinuous structure. The resin product also includes a corrosion-resistant protective film that improves the corrosion resistance of the metallic coating film. The corrosion-resistance of the metallic coating film is made of at least one of a silicon compound, an aluminum compound, a titanium compound, a cerium compound, a zirconium compound, a zinc compound, and a chromium compound, and is provided only in a position under the metallic coating film.

### INCORPORATION BY REFERENCE

The present application claims priority under 35 U.S.C. §119 to Japanese Patent Application No. 2006-264910 filed on Sep. 28, 2006, which is incorporated herein by reference in its entirety.

### TECHNICAL FIELD

The present invention relates to a resin product with a metallic coating film.

### BACKGROUND OF THE INVENTION

Conventionally, in order to coat a base material with a metallic coating film that has luster while also having a microscopically discontinuous film structure that makes it transmissive of electromagnetic waves such as millimeter waves and the like, it was necessary to apply a base coat to ensure good appearance and adhesion for the metallic coating film. (Refer to Japanese Patent Application Publication No. JP-A-7-316782.) However, with this method, if dust and the like in the atmosphere became mixed into the base coat, defects tended to occur on the surface of the metallic coating film, because the metallic coating film was a thin film, with a thickness of only several nanometers.

Dry processing of the base material has also been tried as a way to coat the base material with the metallic coating film having the microscopically discontinuous film structure, without applying the base coat. However, this method has not been commercialized, because corrosive substances in the base material cause deterioration of the metallic coating film, adhesion is poor between the base material and the metallic coating film, and the base layer has poor durability, so that the metallic coating film is not sufficiently durable.

### SUMMARY OF THE INVENTION

It is an object of the present invention to provide a resin product that includes a luster metallic coating film that is corrosion-resistant without a base coat being applied.

In order to achieve the object described above, the present invention employs means (1) and (2) below.

(1) The resin product according to the present invention includes a resin base material and a luster metallic coating film provided on the resin base material. The metallic coating film is made of indium, and has a discontinuous structure. The resin product also includes a corrosion-resistant protective film that improves the corrosion resistance of the metallic coating film. The corrosion-resistant protective film is made of at least one of a silicon compound, an aluminum compound, a titanium compound, a cerium compound, a zirconium compound, a zinc compound, and a chromium compound, and is provided only in a position under the metallic coating film. In this specification, the corrosion resistance of the metallic coating film means the ability of the metal in the metallic coating film to resist oxidation.

(2) Another resin product according to the present invention includes a resin base material and a luster metallic coating film provided on the resin base material. The metallic coating film is made of tin, and has a discontinuous structure. The resin product also includes a corrosion-resistant protective film that improves the corrosion resistance of the metallic coating film. The corrosion-resistant protective film is made of an inorganic compound, and is provided in at least one of a position on the metallic coating film and a position under the metallic coating film.

Aspects of each element of the present invention will be explained below by examples.

### 1. Resin Base Material

The mode of the resin base material in means (1) and (2) is not specifically limited, but a plate material, a sheet material, a film material, and the like can be given as examples. The resin in the resin base material is also not specifically limited, but a thermoplastic resin is desirable, and polycarbonate (PC), acrylic resin, polystyrene, polyvinyl chloride (PVC), polyurethane, and the like can be given as examples.

### 2. Metallic Coating Film

The metallic coating film is made of one of indium (In) and tin (Sn), which have luster and readily form a discontinuous structure.

The thickness of the metallic coating film is not specifically limited, but a thickness of 10 to 100 nm is desirable. If the thickness is less than 10 nm, the luster tends to diminish, and if the thickness exceeds 100 nm, the discontinuous structure tends not to form.

The method of forming the metallic coating film is not specifically limited, but physical vapor deposition methods such as vacuum vapor deposition, molecular beam vapor deposition, ion plating, ion beam vapor deposition, spattering, and the like can be given as examples.

### 3. Corrosion-Resistant Protective Film

### 3-1. Compounds

For the inorganic compound of the corrosion-resistant protective film in means (2), it is desirable to use a compound that forms a high-density film with a density of 3.0 g/cm³ or greater. Examples of the inorganic compound include the followings (1) to (7), which are classified by silicon and the metallic elements, and (A) to (D), which are classified by the mating elements. Note that the following examples are also examples of the silicon compound, the aluminum compound, the titanium compound, the cerium compound, the zirconium compound, the zinc compound, and the chromium compound in means (1).

(1) For the silicon (Si) compound, silicon oxide (SiO₂ and the like), silicon nitride (Si₃N₄), silicon oxynitride (SiOₓN_{y}), and the like can be given as examples.

(2) For the aluminum (Al) compound, aluminum oxide (Al₂O₃), aluminum nitride (AlN), aluminum oxynitride (AlOₓN_{y}), and the like can be given as examples.

(3) For the titanium (Ti) compound, titanium oxide (TiO₂ and the like), titanium nitride (TiN), and the like can be given as examples.

(4) For the cerium (Ce) compound, cerium oxide (CeO₂ and the like) and the like can be given as examples.

(5) For the zirconium (Zr) compound, zirconium oxide (ZrO₂) and the like can be given as examples.

(6) For the zinc (Zn) compound, zinc sulfide (ZnS), zinc oxide (ZnO), and the like can be given as examples.

(7) For the chromium (Cr), compound, chromium oxide (Cr₂O₃ and the like), chromium nitride (CrN), and the like can be given as examples.

(A) For the oxides (MO), silicon oxide (SiO₂ and the like), aluminum oxide (Al₂O₃), titanium oxide (TiO₂ and the like), cerium oxide (CeO₂ and the like), zirconium oxide (ZrO₂), zinc oxide (ZnO), chromium oxide (Cr₂O₃ and the like), and the like can be given as examples.

(B) For the nitrides (MN), silicon nitride (Si₃N₄), aluminum nitride (AlN), titanium nitride (TiN), chromium nitride (CrN), and the like can be given as examples.

(C) For the oxynitrides (MOₓN_{y}), silicon oxynitride (SiOₓN_{y}), aluminum oxynitride (AlOₓN_{y}), and the like can be given as examples.

(D) For the sulfides (MS), zinc sulfide (ZnS) and the like can be given as examples.

Note that for the silicon oxynitride and aluminum oxynitride, it is desirable for the nitrogen content ratio (the amount of nitrogen divided by the sum of the amounts of nitrogen and oxygen: N/(N+O)) in each oxynitride compound to be from 3 to 80 mol %, because corrosion resistance improves when the nitrogen content ratio is in this range.

### 3-2. Film-Forming Method

The method of forming the corrosion-resistant protective film is not specifically limited, but a vapor deposition method is desirable from the standpoint of preventing surface defects. Among the vapor deposition methods, vacuum vapor deposition, molecular beam vapor deposition, ion plating, ion beam vapor deposition, spattering, and the like can be given as examples of physical vapor deposition, while thermochemical vapor deposition, plasma chemical vapor deposition, photochemical vapor deposition, and the like can be given as examples of chemical vapor deposition.

### 3-3. Position

The corrosion-resistant protective film in means (1) is provided in a position under the metallic coating film. The corrosion-resistant protective film in means (2) is provided in at least one of a position on the metallic coating film and a position under the metallic coating film. It is desirable that the corrosion-resistant protective film is provided in a position in which it is in contact with the metallic coating film, but it may be provided with another film layer interposed between the corrosion-resistant protective film and the metallic coating film. However, in a case where the corrosion-resistant protective film is provided under the metallic coating film, the corrosion-resistant protective film is provided between the metallic coating film and the resin base material, that is, in a position on the resin base material.

### 3-4. Film Thickness

It is desirable for the thickness of the corrosion-resistant protective film to be from 2 to 100 nm, and it is even more desirable for the thickness to be from 3 to 50 nm. If the thickness is less than 2 nm, sufficient corrosion resistance cannot be obtained, and if the thickness exceeds 100 nm, the spread of strain within the film causes cracking and the like.

### 4. Other Films

In means (1) and (2), a protective film (press coating film) may be provided over the metallic coating film to protect the metallic coating film. The type of the protective film is not specifically limited, but a resin coating film and the like can be given as examples.

### 5. Resin Product Uses

The discontinuous structure of the metallic coating film gives the resin product qualities such as being transmissive of millimeter waves, because the electrical resistance of the resin product is high, and being corrosion-resistant, because the discontinuous structure inhibits the propagation of corrosion. Because of these qualities, although the uses of the resin product are not specifically limited, the uses listed below can be given as examples.

(a) Because the resin product is transmissive of millimeter waves, it can, for example, be used as a cover for a millimeter-wave radar unit. The locations where the cover can be used are not specifically limited, but its use on automobile exterior coated products is desirable, and it is especially well-suited to a radiator grill, a grill cover, a side molding, a back panel, a bumper, an emblem, and the like.

(b) Because the resin product is corrosion-resistant, it can, for example, be used for automobile exterior parts such as an emblem, a radiator grill, a luster molding, and the like.

According to the present invention, a resin product can be provided that includes a luster metallic coating film that is corrosion-resistant without a base coat being applied.

### BRIEF DESCRIPTION OF THE DRAWINGS

FIG. 1 is a schematic sectional view of an example in which a metallic coating film is made of indium; and

FIG. 2 is a schematic sectional view of an example in which the metallic coating film is made of tin.

### DETAILED DESCRIPTION OF THE INVENTION

A resin product includes a resin base material, and a luster metallic coating film provided on the resin base material. The metallic coating film is made of indium, and has a discontinuous structure.

The resin product also includes a corrosion-resistant protective film that improves the corrosion resistance of the metallic coating film. The corrosion-resistant protective film is made of at least one of silicon oxynitride, aluminum nitride, aluminum oxynitride, and chromium oxide, and is provided only in a position under the metallic coating film.

Another resin product includes a resin base material, and a luster metallic coating film provided on the resin base material. The metallic coating film is made of tin, and has a discontinuous structure.

The resin product also includes a corrosion-resistant protective film that improves the corrosion resistance of the metallic coating film. The corrosion-resistant protective film is made of at least one of silicon oxynitride, aluminum nitride, aluminum oxynitride, and chromium oxide, and is provided in at least one of a position on the metallic coating film and a position under the metallic coating film.

### EXAMPLES

Examples and comparative examples of the metallic coating film on a resin base material (substrate) made of polycarbonate, as shown in Table 1 below, will be explained below. The examples and comparative examples vary according to the type of the metallic coating film, the method by which the metallic coating film was formed, the presence or absence of the corrosion-resistant protective film which is provided on or under the metallic coating film, the type of the corrosion-resistant protective film, and the method by which the corrosion-resistant protective film was formed. Note that the examples of the present invention and the comparative examples are divided into nine groups by study item.

TABLE 1

| | | Film Configuration | | | | | |
|---|---|---|---|---|---|---|---|
| | | | | | | Corrosion-resistant | |
| | | Corrosion-resistant | | | | protective film 14 | |
| | | protective film 13 | | | | provided on | |
| | | provided under | | | | metallic coating film | |
| | | metallic coating film | | | | Material/ | |
| | | Material/ | | Metallic coating film 12 | | Nitrogen content | |
| | | Nitrogen content | Film | | Film | Ratio/ | |
| Study | | Ratio/ | thickness | Material/ | thickness | (Film-forming | Film thickness |
| Group | Category | (Film-forming method) | (nm) | (Film-forming method) | (nm) | method) | (nm) |
| 1a | Comparative | None | — | In (vacuum vapor | 40 | None | |
| | Example | | | deposition) | | | |
| | Example | Silicon oxide | 10 | In (vacuum vapor | 40 | None | |
| | | (ion plating) | | deposition) | | | |
| | Example | Aluminum oxide | 10 | In (vacuum vapor | 40 | None | |
| | | (ion plating) | | deposition) | | | |
| | Example | Aluminum nitride | 10 | In (vacuum vapor | 40 | None | |
| | | (ion plating) | | deposition) | | | |
| | Example | Titanium oxide | 10 | In (vacuum vapor | 40 | None | |
| | | (ion plating) | | deposition) | | | |
| | Example | Cerium oxide | 10 | In (vacuum vapor | 40 | None | |
| | | (ion plating) | | deposition) | | | |
| | Example | Zirconium oxide | 10 | In (vacuum vapor | 40 | None | |
| | | (ion plating) | | deposition) | | | |
| | Example | Zinc sulfide | 10 | In (vacuum vapor | 40 | None | |
| | | (ion plating) | | deposition) | | | |
| 1b | Comparative | None | — | Sn (vacuum vapor | 40 | None | |
| | Example | | | deposition) | | | |
| | Example | Silicon oxynitride | 30 | Sn (vacuum vapor | 40 | None | |
| | | 60% (spattering) | | deposition) | | | |
| | Example | Aluminum oxide | 30 | Sn (vacuum vapor | 40 | None | |
| | | (vacuum vapor | | deposition) | | | |
| | | deposition) | | | | | |
| 2a | Comparative | None | — | Sn (vacuum vapor | 40 | None | |
| | Example | | | deposition) | | | |
| | Example | Silicon oxide | 10 | Sn (vacuum vapor | 40 | None | |
| | | (vacuum vapor | | deposition) | | | |
| | | deposition) | | | | | |
| | Example | Silicon oxynitride | 10 | Sn (vacuum vapor | 40 | None | |
| | | 4% (vacuum vapor | | deposition) | | | |
| | | deposition) | | | | | |
| | Example | Silicon oxynitride | 10 | Sn (vacuum vapor | 40 | None | |
| | | 10% (ion plating) | | deposition) | | | |
| | Example | Silicon oxynitride | 10 | Sn (vacuum vapor | 40 | None | |
| | | 20% (ion plating) | | deposition) | | | |
| 2b | Comparative | None | — | In (spattering) | 40 | None | |
| | Example | | | | | | |
| | Example | Silicon oxide | 10 | In (spattering) | 40 | None | |
| | | (spattering) | | | | | |
| | Example | Silicon oxynitride | 10 | In (spattering) | 40 | None | |
| | | 5% (spattering) | | | | | |
| | Example | Silicon oxynitride | 10 | In (spattering) | 40 | None | |
| | | 20% (spattering) | | | | | |
| | Example | Silicon oxynitride | 10 | In (spattering) | 40 | None | |
| | | 60% (spattering) | | | | | |
| | Example | Silicon nitride | 10 | In (spattering) | 40 | None | |
| | | (spattering) | | | | | |
| 3a | Comparative | None | — | In (vacuum vapor | 40 | None | |
| | Example | | | deposition) | | | |
| | Example | Aluminum oxide | 10 | In (vacuum vapor | 40 | None | |
| | | (ion plating) | | deposition) | | | |
| | Example | Aluminum oxynitride | 10 | In (vacuum vapor | 40 | None | |
| | | 4% (ion plating) | | deposition) | | | |
| | Example | Aluminum oxynitride | 10 | In (vacuum vapor | 40 | None | |
| | | 20% (ion plating) | | deposition) | | | |
| | Example | Aluminum oxynitride | 10 | In (vacuum vapor | 40 | None | |
| | | 60% (ion plating) | | deposition) | | | |
| | Example | Aluminum nitride | 10 | In (vacuum vapor | 40 | None | |
| | | (ion plating) | | deposition) | | | |
| 3b | Comparative | None | — | In (vacuum vapor | 80 | None | |
| | Example | | | deposition) | | | |
| | Example | Silicon oxide | 10 | In (vacuum vapor | 80 | None | |
| | | (ion plating) | | deposition) | | | |
| | Example | Aluminum oxide | 10 | In (vacuum vapor | 80 | None | |
| | | (ion plating) | | deposition) | | | |
| | Example | Aluminum oxynitride | 10 | In (vacuum vapor | 80 | None | |
| | | 4% (ion plating) | | deposition) | | | |
| | Example | Aluminum oxynitride | 10 | In (vacuum vapor | 80 | None | |
| | | 20% (ion plating) | | deposition) | | | |
| | Example | Aluminum oxynitride | 10 | In (vacuum vapor | 80 | None | |
| | | 60% (ion plating) | | deposition) | | | |
| | Example | Aluminum nitride | 10 | In (vacuum vapor | 80 | None | |
| | | (ion plating) | | deposition) | | | |
| 4a | Comparative | None | — | In (vacuum vapor | 45 | None | |
| | Example | | | deposition) | | | |
| | Example | Chromium oxide | 20 | In (vacuum vapor | 45 | None | |
| | | (ion plating) | | deposition) | | | |
| 4b | Comparative | None | — | Sn (vacuum vapor | 45 | None | |
| | Example | | | deposition) | | | |
| | Example | Chromium oxide | 20 | Sn (vacuum vapor | 45 | Chromium oxide | 20 |
| | | (ion plating) | | deposition) | | (ion plating) | |
| | Example | Chromium oxide | 20 | Sn (vacuum vapor | 45 | Chromium oxide | 10 |
| | | (ion plating) | | deposition) | | (ion plating) | |
| | Example | Chromium oxide | 20 | Sn (vacuum vapor | 45 | Chromium oxide | 2 |
| | | (ion plating) | | deposition) | | (ion plating) | |
| | Example | Chromium oxide | 2 | Sn (vacuum vapor | 45 | Chromium oxide | 2 |
| | | (ion plating) | | deposition) | | (ion plating) | |
| 5 | Comparative | None | — | Sn (vacuum vapor | 40 | None | |
| | Example | | | deposition) | | | |
| | Example | None | — | Sn (vacuum vapor | 40 | Silicon oxynitride | 30 |
| | | | | deposition) | | 60% (spattering) | |
| | Example | None | — | Sn (vacuum vapor | 40 | Silicon oxynitride | 100 |
| | | | | deposition) | | 60% (spattering) | |
| | Comparative | None | — | Sn (vacuum vapor | 40 | Aluminum | 30 |
| | Example | | | deposition) | | oxynitride | |
| | | | | | | 20% (vacuum | |
| | | | | | | vapor | |
| | | | | | | deposition) | |
| | Comparative | None | — | Sn (vacuum vapor | 40 | Aluminum | 100 |
| | Example | | | deposition) | | oxynitride 20% | |
| | | | | | | (vacuum vapor | |
| | | | | | | deposition) | |

| | | | Corrosion | | | | |
|---|---|---|---|---|---|---|---|
| | | | resistance | | | Adhesion | |
| | | | (Environmental | | | Abrasion | |
| | | | resistance test) | | | resistance/ | |
| | | | Moisture | | | Gauze | |
| | | | resistance | | | abrasion | |
| | | | Measured | | | Measured | |
| | | | value | | | value | |
| | | | Amount | | | Amount | |
| | | | of | | | of | |
| | | | change | | | change | |
| | | Film Configuration | in | | | in | |
| Study | | Press coating film 15 | transmittance | | | transmittance | |
| Group | Category | (Protective film) | (%) | ΔE | Evaluation | (%) | Evaluation |
| 1a | Comparative | Yes | | 3.1 | X | | |
| | Example | | | | | | |
| | Example | Yes | | 1.4 | ◯ | | |
| | Example | Yes | | 0.7 | ⊚ | | |
| | Example | Yes | | 0.5 | ⊚ | | |
| | Example | Yes | | 2.2 | Δ | | |
| | Example | Yes | | 1.3 | ◯ | | |
| | Example | Yes | | 1.9 | ◯ | | |
| | Example | Yes | | 2.9 | Δ | | |
| 1b | Comparative | Yes | | 5.3 | X | | |
| | Example | | | | | | |
| | Example | Yes | | 1.8 | ◯ | | |
| | Example | Yes | | 2.6 | Δ | | |
| 2a | Comparative | No | 25.3 | | X | 95 | X |
| | Example | | | | | | |
| | Example | No | 8.9 | | Δ | 22 | ◯ |
| | Example | No | 0.8 | | ◯ | 16.8 | ◯ |
| | Example | No | −2.8 | | ◯ | 3.8 | ◯ |
| | Example | No | 0.4 | | ◯ | 0.5 | ⊚ |
| 2b | Comparative | Yes | | 4.3 | X | | |
| | Example | | | | | | |
| | Example | Yes | | 2.8 | Δ | | |
| | Example | Yes | | 1.7 | ◯ | | |
| | Example | Yes | | 1.6 | ◯ | | |
| | Example | Yes | | 1.8 | ◯ | | |
| | Example | Yes | | 1.9 | ◯ | | |
| 3a | Comparative | Yes | | 3.1 | X | | |
| | Example | | | | | | |
| | Example | Yes | | 1.1 | ◯ | | |
| | Example | Yes | | 0.4 | ⊚ | | |
| | Example | Yes | | 0.4 | ⊚ | | |
| | Example | Yes | | 0.5 | ⊚ | | |
| | Example | Yes | | 0.6 | ⊚ | | |
| 3b | Comparative | Yes | | 3.3 | X | | |
| | Example | | | | | | |
| | Example | Yes | | 1.0 | ◯ | | |
| | Example | Yes | | 0.5 | ⊚ | | |
| | Example | Yes | | 0.7 | ⊚ | | |
| | Example | Yes | | 0.6 | ⊚ | | |
| | Example | Yes | | 0.5 | ⊚ | | |
| | Example | Yes | | 2.1 | Δ | | |
| 4a | Comparative | No | 8.2 | | Δ | | |
| | Example | | | | | | |
| | Example | No | 0.9 | | ⊚ | | |
| 4b | Comparative | No | 25.3 | | X | | |
| | Example | | | | | | |
| | Example | No | −1.5 | | ◯ | | |
| | Example | No | 1.6 | | ◯ | | |
| | Example | No | 2.8 | | ◯ | | |
| | Example | No | 9.8 | | Δ | | |
| 5 | Comparative | No | 31.5 | | X | | |
| | Example | | | | | | |
| | Example | No | 2.12 | | ◯ | | |
| | Example | No | 2.52 | | ◯ | | |
| | Comparative | No | 93.1 | | XX | | |
| | Example | | | | | | |
| | Comparative | No | 91.2 | | XX | | |
| | Example | | | | | | |

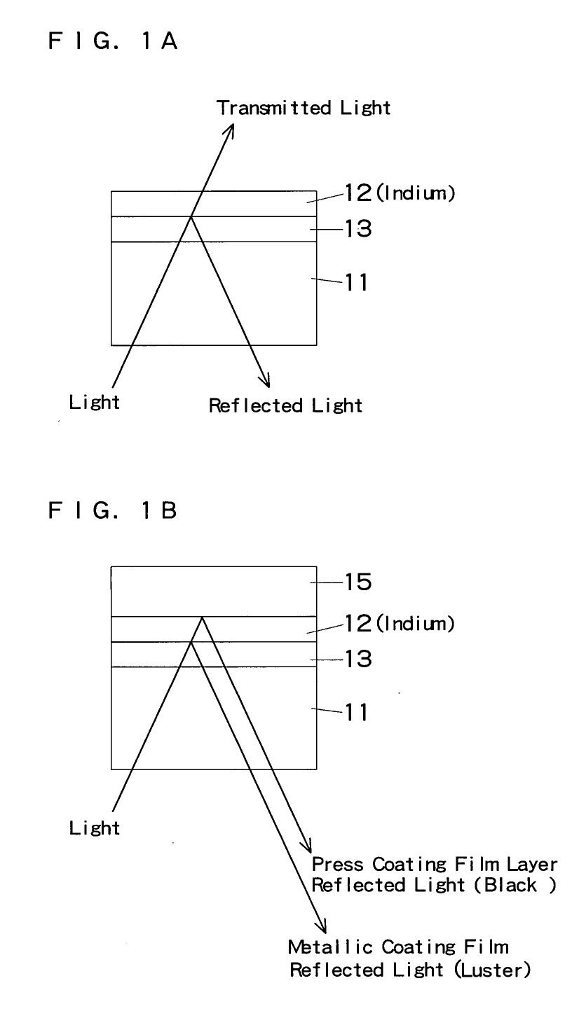

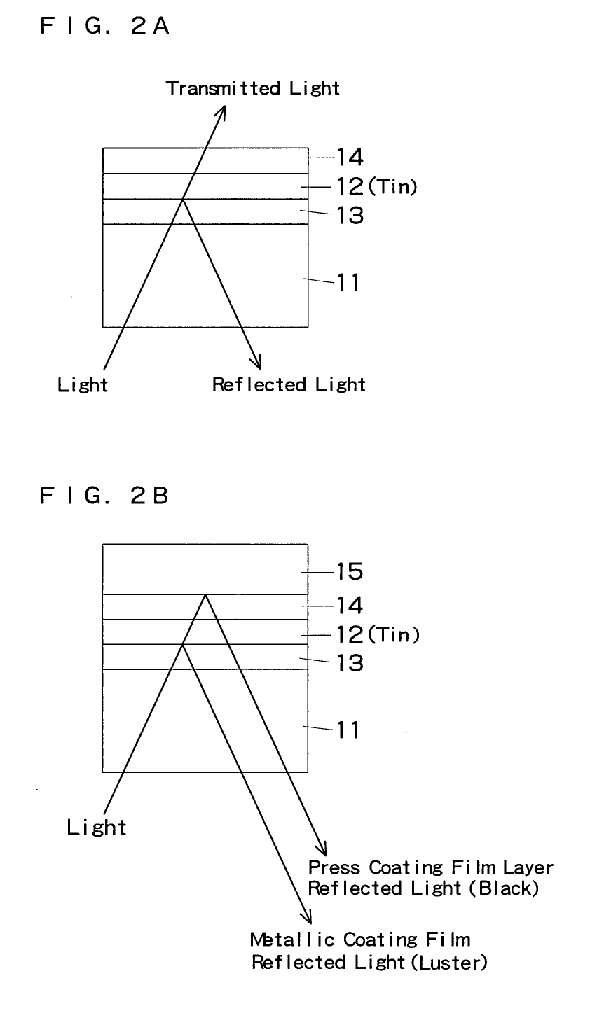

As shown in FIGS. 1 and 2, each test piece that was used included a resin base material 11 made of polycarbonate with a thickness of 5 mm, on which a metallic coating film 12, as well as a corrosion-resistant protective film 14 which is provided on the metallic coating film 12 (hereinafter, “overlying corrosion-resistant protective film 14”), a corrosion-resistant protective film 13 which is provided under the metallic coating film 12 (hereinafter, “underlying corrosion-resistant protective film 13”), or both the underlying and overlying corrosion-resistant protective films 13, 14 were formed. In a case where the test piece had a press coating film 15, the press coating film 15 was formed using a two-component type, thermal drying, black acrylic material, and the film thickness was 15 μm.

### <Oxynitride Films>

In this example, oxynitride films were formed, and their nitrogen content ratios were measured, as described below.

(a) Film-Forming Method

Films of silicon oxynitride and aluminum oxynitride were formed as described below.

A film of silicon oxynitride (SiOₓN_{y}) formed by spattering, using silicon (Si) in a target and using the partial pressures of nitrogen (N₂) and oxygen (O₂) in the atmosphere to control the composition.

A film of silicon oxynitride (SiOₓN_{y}) formed by ion plating, using silicon nitride (Si₃N₄) in an evaporation material and using an output of an RF plasma in a nitrogen (N₂) (oxygen (O₂)) atmosphere to control the composition.

A film of silicon oxynitride (SiOₓN_{y}) formed by vacuum vapor deposition, using silicon nitride (Si₃N₄) in an evaporation material.

A film of aluminum oxynitride (AlOₓN_{y}) formed by spattering, using aluminum (Al) in a target and using the partial pressures of nitrogen (N₂) and oxygen (O₂) in the atmosphere to control the composition.

A film of aluminum oxynitride (AlOₓN_{y}) formed by ion plating, using aluminum nitride (AlN) in an evaporation material and using an output of an RF plasma in a nitrogen (N₂) atmosphere to control the composition.

(b) Nitrogen Content Ratios

The nitrogen content ratios (N/(O+N)) of the films were measured by X-ray photoelectron spectroscopy (XPS).

### <Group 1a>

In this group of examples, the indium metallic coating film 12 was formed by vacuum vapor deposition. Silicon oxide, aluminum oxide, aluminum nitride, titanium oxide, cerium oxide, zirconium oxide, and zinc sulfide films formed by ion plating were provided as the underlying corrosion-resistant protective films 13. The press coating film 15 was provided over the indium metallic coating film 12. In the comparative example, the underlying corrosion-resistant protective film 13 was not provided.

### <Group 1b>

In this group of examples, the metallic coating film 12 was changed to tin formed by vacuum vapor deposition, in contrast to group la. The underlying corrosion-resistant protective films 13 were changed to films of silicon oxynitride formed by spattering and aluminum oxide formed by vacuum vapor deposition. In the comparative example, the underlying corrosion-resistant protective film 13 was not provided.

### <Group 2a>

In this group of examples, the tin metallic coating film 12 was formed by vacuum vapor deposition. Silicon oxynitride films (including silicon oxide and silicon nitride) formed by vacuum vapor deposition and by ion plating, and having different nitrogen content ratios, were provided as the underlying corrosion-resistant protective films 13. In the comparative example, the underlying corrosion-resistant protective film 13 was not provided.

### <Group 2b>

In this group of examples, in contrast to group 2a, the metallic coating film 12 was changed to indium formed by spattering, and the press coating film 15 was provided over the indium metallic coating film 12. In the comparative example, the underlying corrosion-resistant protective film 13 was not provided.

### <Group 3a>

In this group of examples, the indium metallic coating film 12 was formed by vacuum vapor deposition. Aluminum oxynitride films (including aluminum oxide and aluminum nitride) formed by ion plating, and having different nitrogen content ratios, were provided as the underlying corrosion-resistant protective films 13. The press coating film 15 was provided over the indium metallic coating film 12. In the comparative example, the underlying corrosion-resistant protective film 13 was not provided.

### <Group 3b>

In this group of examples, in contrast to group 3a, the thickness of the indium metallic coating film 12 was increased, and the underlying corrosion-resistant protective films 13 were changed to silicon oxide films formed by ion plating. In the comparative example, the underlying corrosion-resistant protective film 13 was not provided.

### <Group 4a>

In this group of examples, the indium metallic coating film 12 was formed by vacuum vapor deposition. A chromium oxide film formed by ion plating was provided as the underlying corrosion-resistant protective film 13. In the comparative example, the underlying corrosion-resistant protective film 13 was not provided.

### <Group 4b>

In this group of examples, in contrast to group 4a, the metallic coating film 12 was changed to tin formed by vacuum vapor deposition. Both the underlying and overlying corrosion-resistant protective films 13, 14 made of chromium oxide were provided, and the thicknesses of the underlying and overlying corrosion-resistant protective films 13, 14 were varied. In the comparative example, the underlying and overlying corrosion-resistant protective films 13, 14 were not provided.

### <Group 5>

In this group of examples, the underlying corrosion-resistant protective film 13 was not provided. Only the overlying corrosion-resistant protective film 14, made of silicon oxynitride and formed by spattering, was provided on the tin metallic coating film 12 formed by vacuum vapor deposition. In one comparative example, neither of the underlying and overlying corrosion-resistant protective films 13, 14 was provided. In the other comparative examples, the overlying corrosion-resistant protective film 14, made of aluminum oxynitride and formed by vacuum vapor deposition, was provided.

### <Corrosion Resistance (Environmental Resistance Test)>

Moisture resistance was tested in order to evaluate corrosion resistance (environmental resistance).

(a) Test Conditions

Moisture resistance was tested under the following conditions:

Humidity: 98% to 100%

Temperature: 40° C.

Time: 480 hours

(b) Evaluation Methods

Amount of change in transmittance

In cases where the press coating film was not provided, as shown in FIGS. 1A and 2A, light was directed from the direction of the resin base material 11, and the transmittance was measured based on the transmitted light that passed through the resin base material 11 and the films 12, 13, 14. The moisture resistance test causes the indium and tin to oxidize, which makes the metallic coating film 12 (luster layer) transparent, increasing the transmittance of the light. Accordingly, the transmittance was measured before and after the moisture resistance test to determine the amount of change in the transmittance from before the test to after the test. The evaluations were then made based on the amount of change in the transmittance.

Color change: ΔE (Change in hue)

In cases where the press coating film was provided, as shown in FIGS. 1B and 2B, the hue of a test piece was measured from the direction of the resin base material 11. The moisture resistance test causes the indium and tin to oxidize, which makes the metallic coating film 12 (luster layer) transparent, such that the black press coating film (protective film) behind the metallic coating film appears transparent. Accordingly, the hue was measured before and after the moisture resistance test. The color change (ΔE) from before the test to after the test was determined by the equation shown below, in accordance with JIS K5600-4-6. The evaluations were then made based on the color change.

ΔE=\sqrt{(ΔL)²+(Δa)²+(Δb)²} Equation 1

ΔL: Luminance difference

Δa: Chromaticity difference (red-green direction)

Δb: Chromaticity difference (yellow-blue direction)

The evaluations were conducted as described below.

(a) As shown by the results for group 1a and group 1b, in the examples which were provided with the underlying corrosion-resistant protective film 13, the corrosion resistance was improved in comparison to the comparative examples which was not provided with the underlying corrosion-resistant protective film 13. In the examples, in which the film made of aluminum oxide (by vacuum vapor deposition), silicon oxide, cerium oxide, zirconium oxide, tinanium oxide, silicon oxynitride, or zinc sulfide was used as the underlying corrosion-resistant protective film 13, the improvement in the corrosion resistance was smaller than the other examples. This is considered to be due to the low denseness of the film and the effects of damage to the film from the oxygen and oxygen plasmas during the formation of the film.

(b) As shown by the results for group 2a, group 2b, group 3a, and group 3b, in the examples, in which the film made of silicon oxynitride, aluminum oxynitride or the like was used as the underlying corrosion-resistant protective film 13, the corrosion resistance was improved in comparison to the comparative examples which was not provided with the underlying corrosion-resistant protective film 13. In the examples, in which the film made of silicon nitride or aluminum nitride was used as the underlying corrosion-resistant protective film 13, the improvement in the corrosion resistance was smaller than the other examples. This is considered to be due to the effects of damage to the film from the high-output plasmas that are required during the formation of the film.

(c) As shown by the results for group 4a and group 4b, in the examples, in which the film or films made of chromium oxide was used as the underlying corrosion-resistant protective film 13 or the underlying and overlying corrosion-resistant protective films 13, 14, respectively, the corrosion resistance was improved in comparison to the comparative examples which were not provided with the underlying or overlying corrosion-resistant protective film 13, 14.

(d) The results for group 5 showed an effect of the corrosion resistance with a nitrogen content ratio of 60 mol % in the silicon oxynitride.

### <Adhesion (Abrasion Resistance)>

The adhesion (abrasion resistance) between the metallic coating film 12 and the resin base material 11 was evaluated by conducting a gauze abrasion test using a test material of group 2b.

(a) Test Conditions

The gauze abrasion test was conducted under the following conditions:

A (100% cotton) gauze 12 mm wide was used as an abrasive material. A load of 6.9 N was applied to the gauze, and the gauze was moved reciprocally 100 times over a distance of 30 mm.

(b) Evaluation Method

Amount of change in transmittance

The transmittance was measured as described above. The gauze abrasion test reduces the thickness of the metallic coating film 12 (luster layer), increasing the transmittance of the light. Accordingly, the transmittance was measured before and after the gauze abrasion test to determine the amount of change in the transmittance from before the test to after the test. The amount of change in the transmittance was then used as the evaluation of adhesion.

It was seen that the adhesion increased to the extent that the nitrogen content ratio of the silicon oxynitride increased.

Note that the present invention is not limited by the examples described above, and that the structure of each part may be freely modified without departing from the spirit and scope of the present invention.

What is claimed is:

1. A resin product comprising:
a resin base material;
a luster metallic coating film provided on the resin base material, the metallic coating film being made of indium, and having a discontinuous structure; and
a corrosion-resistant protective film that improves the corrosion resistance of the metallic coating film;
wherein the corrosion-resistant protective film is made of at least one of a silicon compound, an aluminum compound, a titanium compound, a cerium compound, a zirconium compound, a zinc compound, and a chromium compound, and is provided only in a position under the metallic coating film.

2. The resin product according to claim 1, wherein the one of the silicon compound, the aluminum compound, the titanium compound, the cerium compound, the zirconium compound, the zinc compound, and the chromium compound is one of an oxide, a nitride, an oxynitride, and a sulfide.

3. The resin product according to claim 1, wherein the silicon compound is one of a silicon oxide and a silicon oxynitride.

4. A resin product comprising:
a resin base material;
a luster metallic coating film provided on the resin base material, the metallic coating film being made of tin, and having a discontinuous structure; and
a corrosion-resistant protective film that improves the corrosion resistance of the metallic coating film;
wherein the corrosion-resistant protective film is made of an inorganic compound , and is provided in at least one of a position on the metallic coating film and a position under the metallic coating film.

5. The resin product according to claim 4, wherein the inorganic compound is one of a silicon compound, a chromium oxide, and an aluminum oxide.

6. The resin product according to claim 5, wherein the silicon compound is one of a silicon oxide and a silicon oxynitride.

7. The resin product according to claim 1, wherein the corrosion-resistant protective film is formed by vapor deposition.

8. The resin product according to claim 2, wherein the corrosion-resistant protective film is formed by vapor deposition.

9. The resin product according to claim 3, wherein the corrosion-resistant protective film is formed by vapor deposition.

10. The resin product according to claim 4, wherein the corrosion-resistant protective film is formed by vapor deposition.

11. The resin product according to claim 5, wherein the corrosion-resistant protective film is formed by vapor deposition.

12. The resin product according to claim 6, wherein the corrosion-resistant protective film is formed by vapor deposition.
